(19) United States
(12) Patent Application Publication
(10) Pub. No.: US 2017/0144123 A1
(43) Pub. Date: May 25, 2017

(54) Solid aggregates of microparticles, system and method for producing such aggregates

(71) Applicant: ECOLE SUPERIEURE DE PHYSIQUE ET DE CHIMIE INDUSTRIELLES DE LA VILLE DE PARIS, Paris (FR)

(72) Inventors: Patrick Tabeling, Paris (FR); Joshua Ricouvier, Paris (FR); Bingqing Shen, Chatillon (FR)

(21) Appl. No.: 15/359,863

(22) Filed: Nov. 23, 2016

(30) Foreign Application Priority Data
Nov. 23, 2015 (FR) 1561273

(51) Int. Cl. B01J 13/14; B01J 2/10

(52) U.S. Cl. CPC B01J 13/14; B01J 2/10

(57) ABSTRACT

The present invention lies within the field of colloidal assemblies and relates to a system for producing solid clusters of microparticles, characterized in that it comprises at least:
a fluidic device comprising at least:
   an element for producing primary droplets, comprising an outlet of width l₁ and
   a main channel for forming solid clusters, having a main axis, of height h₂ and comprising an inlet of width l₂;
said element for producing primary droplets being connected to said inlet of said main channel, h₁ being less than h₂, so as to form a step between said element for producing primary droplets and said main channel and l₁ being strictly less than l₂;
a system of physical initiation of polymerization capable of initiating polymerization in said main channel.

The invention relates to colloidal assemblies, and more particularly the manufacture of solid clusters of controlled geometries by a microfluidic manufacturing method.

The production of metamaterials by colloidal assemblies can have remarkable advantages: by manufacturing building blocks having controlled chemical, geometric or magnetic properties, it may be possible to manufacture by spontaneous assembly metamaterials having novel and predictable features (such as a photonic crystal for example).

The formation of large quantities of colloidal assemblies is generally based on methods carried out in volume. An example of a method of volume production of colloidal assemblies is disclosed in Wang, Y., Wang, Y., Breed, D. R., Manoharan, V. N., Feng, L., Hollingsworth, A.D., . . . & Pine, D. J. (2012), Colloids with valence and specific directional bonding, Nature, 491(7422), 51-55. This method consists in producing clusters in volume in several steps. A first step comprises the formation of clusters by a so-called emulsion-evaporation method (described in Manoharan, V. N., Elsesser, M. T., & Pine, D. J., 2003, Dense packing and symmetry in small clusters of microspheres, Science, 301(5632), 483-487), making it possible to form clusters of polystyrene beads, of different conformations and isotropies. These particles are then amidinated so as to create polystyrene surfaces only on the poles of the cluster. Finally, these poles are functionalized with DNA so as to construct assemblies of clusters obtained by controlled hybridization of complementary DNA sequences. This method makes it possible to produce assemblies that mimic both the geometry and the chemistry of a molecule.

This method has several limitations. On the one hand, it is impossible to obtain a collection or a composition of monodisperse clusters with this method. It can be adapted to manufacture clusters in volume, but requires filtering steps of limited selectivity to produce a collection of a given cluster. The chemistry involved in this method also limits the usable materials: they must be compatible with the use of DNA and attachment proteins and with DNA hybridization between the clusters. This method also involves numerous steps, of which some, like the massive use of DNA, can prove to be expensive when manufacturing metamaterials.

The doctoral dissertation of B. Q. Shen (Shen, B. Q., 2014, Transport and self-assembly of droplets in microfluidic devices, Doctoral dissertation, Université Pierre et Marie Curie-Paris VI) describes a method for producing clusters of gelled microparticles. A reagent, TEOS (tetraethyl orthosilicate), is introduced into an aqueous phase. Clusters of droplets of this aqueous phase are formed in microfluidic channels downstream. This aqueous phase polymerizes according to a sol-gel process, so as to gel each droplet of a cluster. This method does not make it possible to bind together in a solid manner the microparticles of a cluster. When the clusters produced are rinsed, the weak adhesion between the microparticles of a cluster causes the various gelled microparticles to separate.

The invention is directed at remedying the above-mentioned disadvantages of the prior art, and more particularly at mass producing monodisperse collections of solid clusters the conformation of which is controlled and potentially anisotropic.

An object of the invention making it possible to achieve this goal is a system for producing solid clusters of at least two substantially ellipsoidal microparticles, characterized in that it comprises at least:

a fluidic device comprising at least:
an element for producing primary droplets, comprising a plurality of fluidic channels of height h₁, at least one dispersed liquid phase and one continuous liquid phase contained in said fluidic channels, each said dispersed phase comprising monomers selected from at least monomers soluble in said continuous phase, the fluidic channels being arranged so as to form at least one junction selected from a T—junction and an X—junction so that at the junction, primary droplets of each dispersed liquid phase are formed in the continuous liquid phase, and
a main channel for forming solid clusters, having a main axis, of height h₂;

said element for producing primary droplets being connected by said outlet to said inlet of said main channel, h₁ being strictly less than h₂ so as to form a step between said element for producing primary droplets and said main channel, the passage of each primary droplet over the step causing said primary droplet to separate into a plurality of secondary droplets;

a system of physical initiation of polymerization capable of initiating the polymerization of the secondary droplets in said main channel, the polymerized secondary droplets forming solid clusters.

Advantageously, the system comprises at least two second channels, called flow control channels, connected to said main channel, and arranged symmetrically with respect to said main axis.

Advantageously, said system of physical initiation of polymerization of said system is selected from a local illumination system emitting ultraviolet light and a heating system.

Another object of the invention is a process for producing solid clusters of at least two substantially ellipsoidal microparticles comprising at least one type of cross-linked polymer, said process comprising at least the steps of:

generating, in fluidic channels, flows of at least one first phase, called the dispersed phase, comprising monomers capable of forming said type of polymer by cross-linking and comprising at least one type of surfactant compound, and one second phase, called the continuous phase, said monomers being selected from at least monomers soluble in said continuous phase, said fluidic channels coming together to form a junction selected from a T-junction and an X-junction, so as to form at least one primary droplet of the dispersed phase in the continuous phase;

controlling the flows of said dispersed phase(s) and of said continuous phase so as to push each said primary droplet with said continuous phase over a step, toward a main channel, the passage of each primary droplet over said step causing the primary droplet to separate into a plurality of adjacent secondary droplets;

initiating the polymerization of the adjacent secondary droplets transported in said main channel by means of a system of physical initiation of polymerization, the polymerized secondary droplets forming solid clusters.

Advantageously, the solubility of said monomers of said process is greater than 1 g.L⁻¹ in said continuous phase.

Advantageously, the process comprises an additional step consisting in awaiting a stationary spatial reorganization of a group of said adjacent secondary droplets before initiating said polymerization in said group of adjacent secondary droplets.

Advantageously, the dispersed phase comprises at least one initiator of a said polymerization.

Advantageously, at least one said initiator is soluble in said continuous phase.

Advantageously, said dispersed phase comprises a polymerization photoinitiator and said system of physical initiation of polymerization is a local illumination system emitting ultraviolet light, focused into said main channel.

Advantageously, in said process, at least two said adjacent primary droplets are formed during the first step of an implemented process, of at least two said dispersed phases having different chemical compositions.

Advantageously, at least two said adjacent primary droplets are formed during the first step of an implemented process, of at least one said dispersed phase comprising magnetic nano-/microparticles.

Advantageously, said process comprises an additional step consisting in controlling the flow rate in flow control channels, in order to select a spatial arrangement between said secondary droplets before initiating the polymerization of the third step of the implemented process.

Advantageously, said continuous phase of said process comprises a surfactant compound in a concentration at least strictly greater than half of the critical micelle concentration of said surfactant compound in said continuous phase.

Advantageously, at least one monomer comprises at least one group selected from an acrylate group and a diacrylate group.

Another object of the invention is a solid cluster of at least two substantially ellipsoidal microparticles, each said microparticle comprising at least one type of cross-linked polymer, characterized in that each said microparticle is interconnected in an integral and materially continuous manner with at least one other microparticle by a solid junction, said junction comprising at least said type of cross-linked polymer.

Advantageously, at least one said microparticle of said solid cluster is substantially spherical.

Advantageously, the microparticles of said solid cluster are substantially of the same size.

Advantageously, at least one said microparticle of said solid cluster has a chemical composition substantially different from at least one other said microparticle of said solid cluster.

Advantageously, at least one said microparticle of said solid cluster comprises magnetic nano-/microparticles.

Advantageously, at least one said microparticle of said solid cluster comprises fluorescent markers.

Advantageously, the centers of mass of said microparticles of said solid cluster form at least one element selected from a triangle, a parallelepiped, a line, a T, a tetrahedron, a pyramid, a triangular bipyramid, an octahedron, a pentagonal bipyramid and a helix.

Another object of the invention is a composition of solid clusters the coefficient of variation in size of which is less than five percent.

The following description presents several example embodiments of the invention: these examples do not limit the scope of the invention. These example embodiments show both the essential features of the invention and additional features related to the embodiments concerned. In the interest of clarity, the same elements will bear the same reference numbers in the various figures.

The invention will be better understood and other advantages, details and features thereof will become apparent in the following explanatory description, given by way of example with reference to the appended drawings in which:

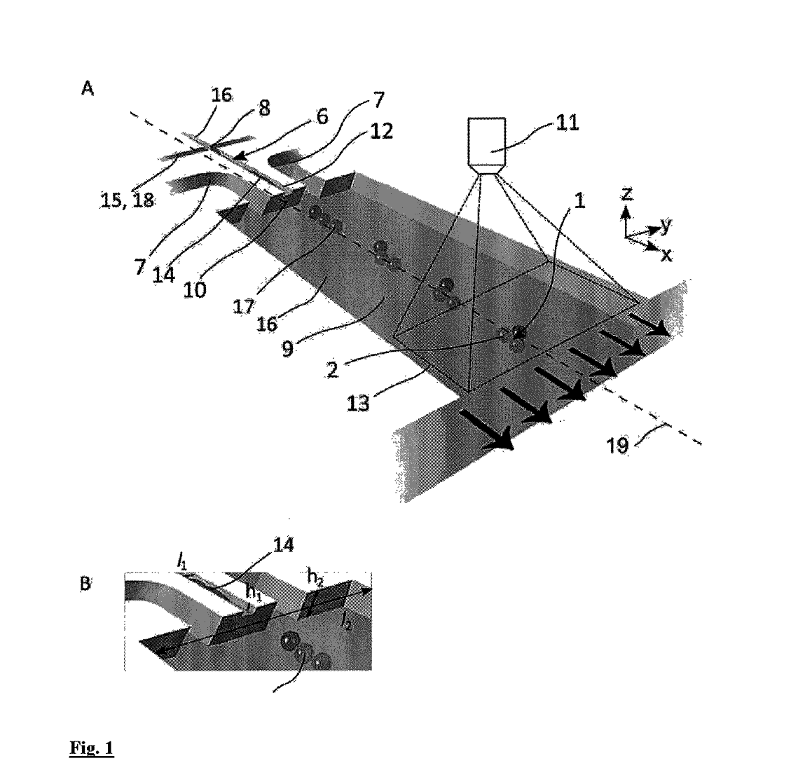

FIG. 1 schematically illustrates a system for producing clusters according to an embodiment of the invention;

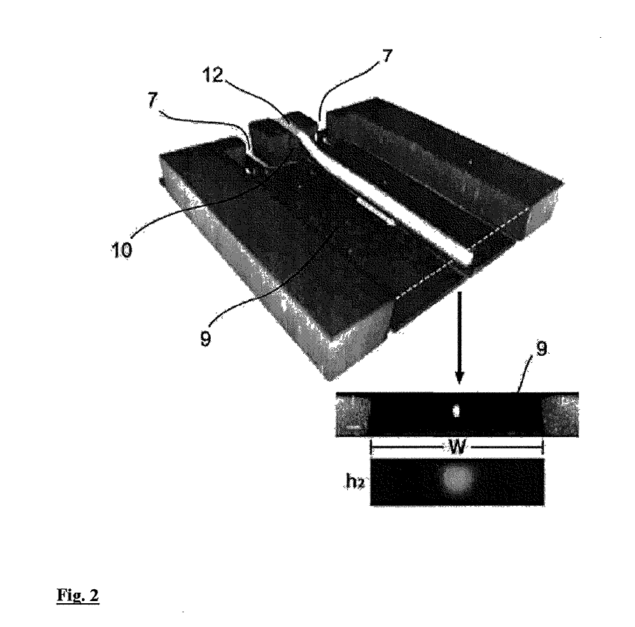

FIG. 2 is a photograph taken under a confocal microscope of part of a system according to an embodiment of the invention;

FIG. 3 illustrates the velocity of clusters of secondary droplets as a function of the mean flow velocity in the main channel;

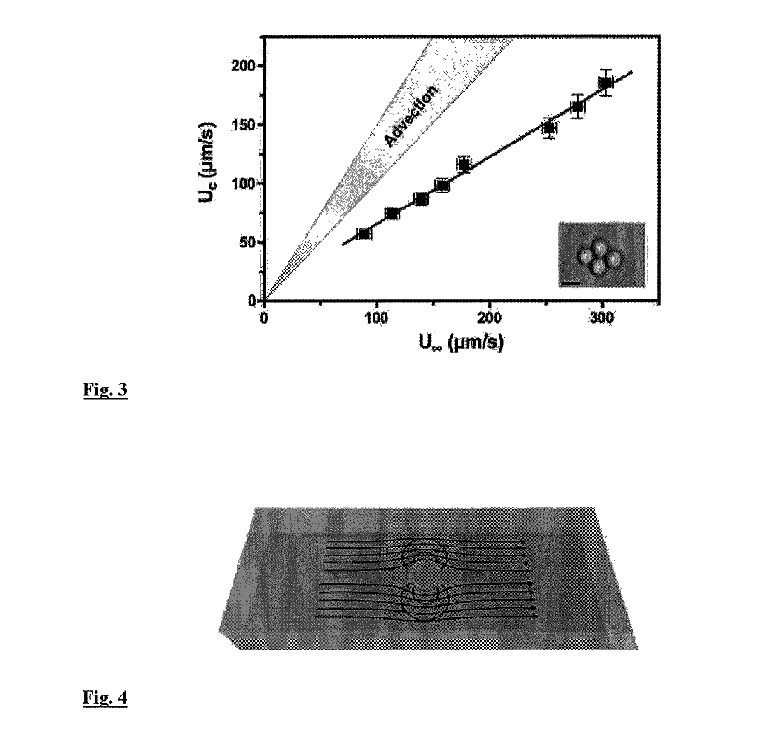

FIG. 4 schematically illustrates the flow field associated with an isolated droplet advected in a microchannel at a velocity below the mean flow velocity;

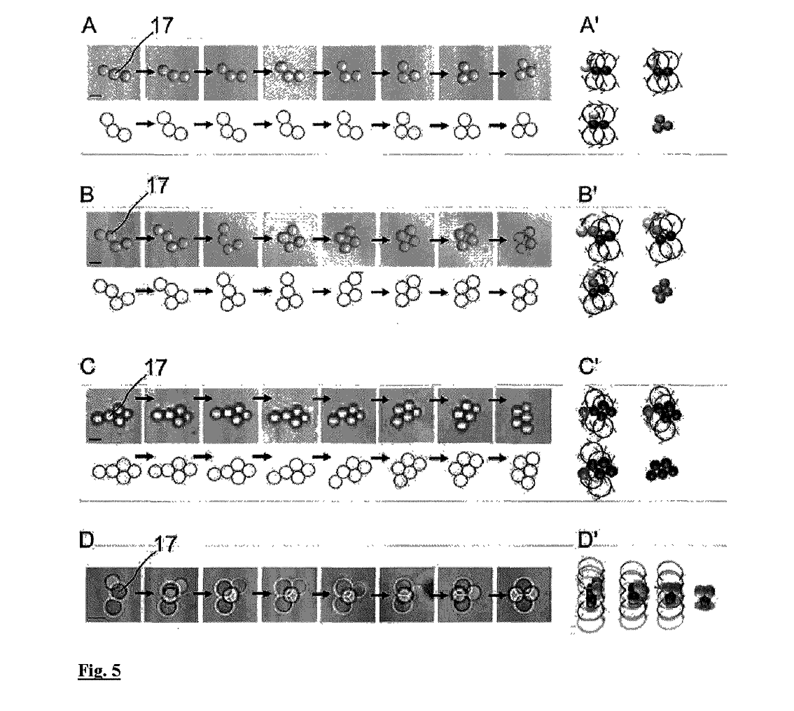

FIG. 5 illustrates the organization dynamics of clusters of secondary droplets;

FIG. 6 illustrates the experimental morphology of the clusters of secondary droplets as a function of the number of contacts between secondary droplets in an cluster and as a function of the number of secondary droplets of the cluster;

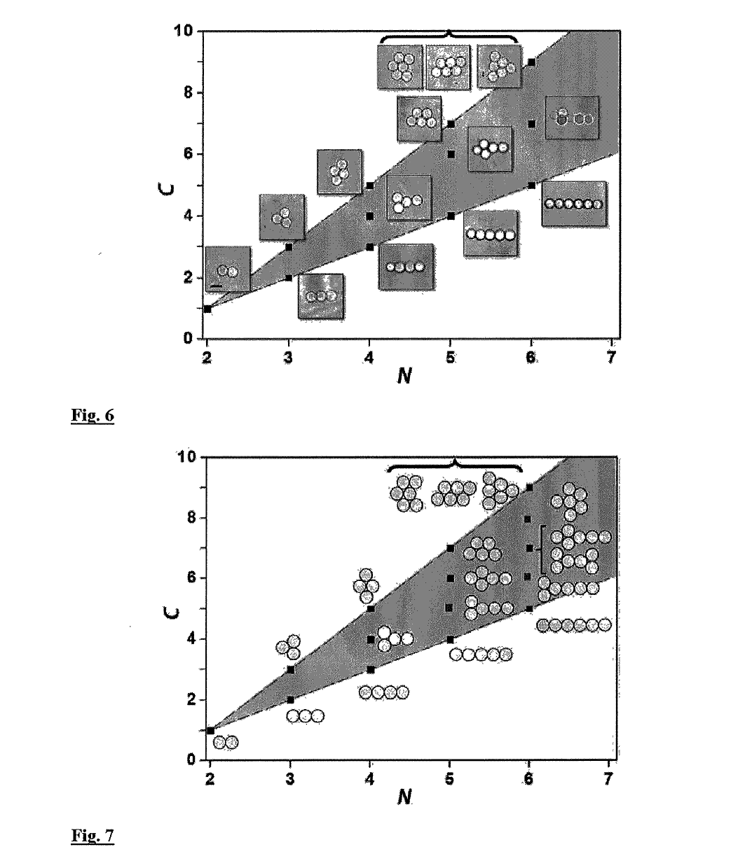

FIG. 7 illustrates the morphology of the clusters of secondary droplets as a function of the number of contacts between secondary droplets in an cluster and as a function of the number of secondary droplets of the cluster, calculated by modeling according to a dipolar model of the forces exerted on the secondary droplets;

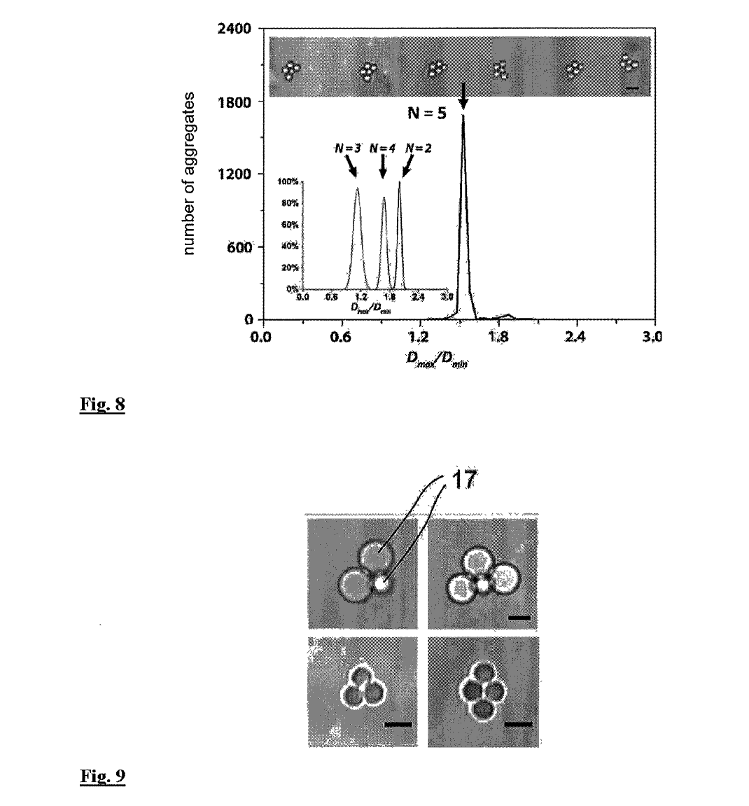

FIG. 8 is a histogram illustrating the aspect ratios of the clusters of secondary droplets;

FIG. 9 illustrates clusters of secondary droplets of different sizes;

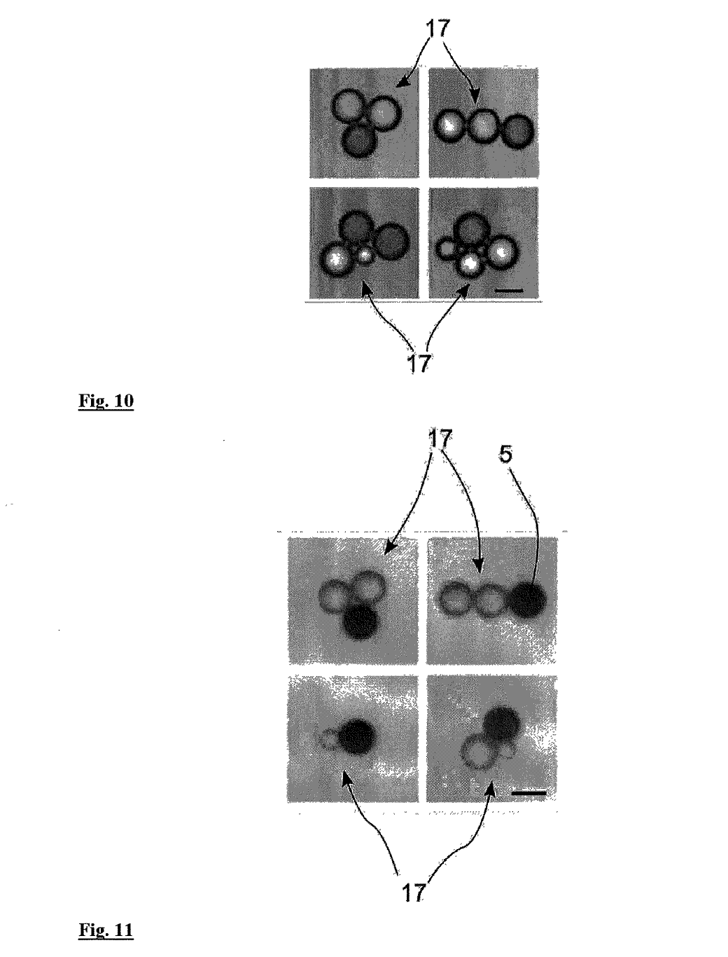

FIG. 10 illustrates clusters of secondary droplets in which at least one secondary droplet has a chemical composition substantially different from at least one other secondary droplet;

FIG. 11 illustrates clusters of secondary droplets in which a secondary droplet comprises magnetic nano-/microparticles;

FIG. 12 illustrates heterogeneous clusters of secondary droplets having three-dimensional conformations;

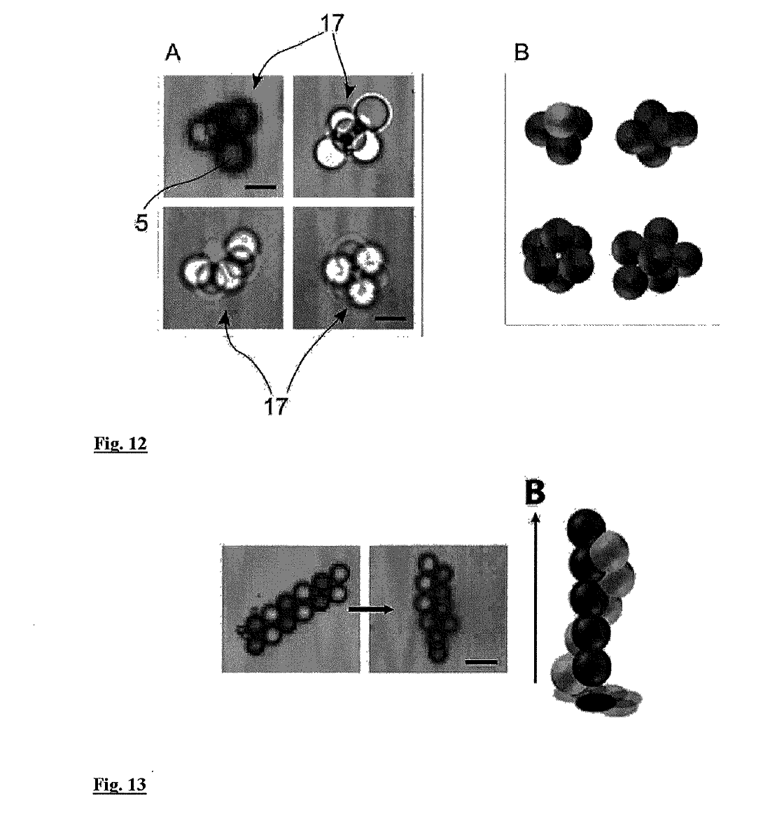

FIG. 13 illustrates heterogeneous clusters of secondary droplets having three-dimensional conformations;

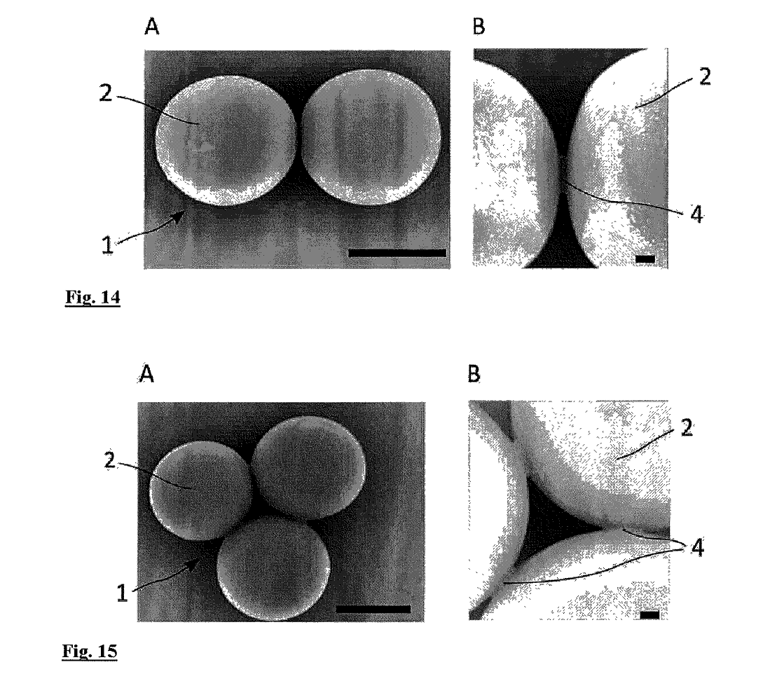

FIG. 14 illustrates a solid cluster according to an embodiment of the invention;

FIG. 15 illustrates a solid cluster according to an embodiment of the invention;

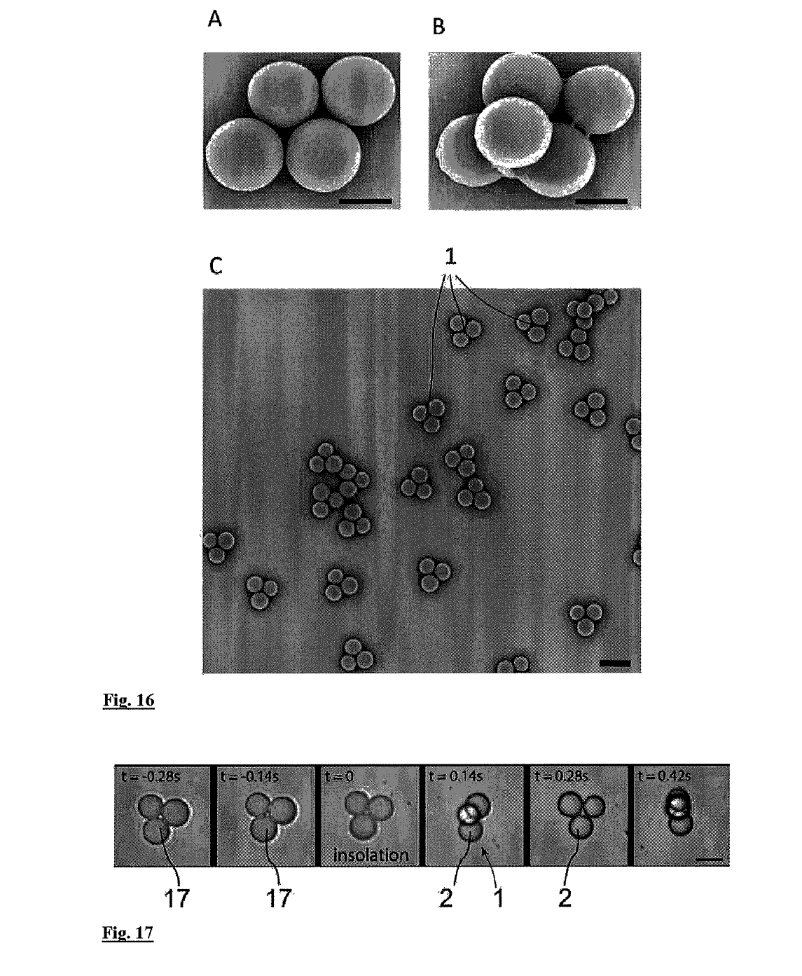

FIG. 16 illustrates the action of a magnetic field on a magnetic cluster of secondary droplets;

FIG. 17 illustrates a step of photopolymerization of an cluster by a process implemented according to an embodiment of the invention;

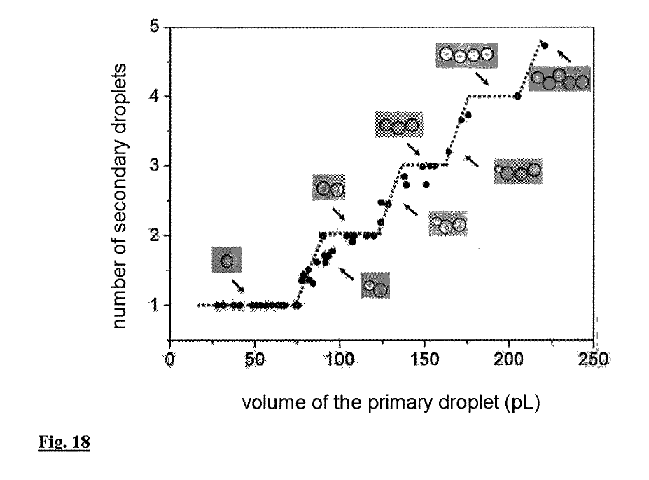

FIG. 18 illustrates the number of secondary droplets produced after passing over a step as a function of the volume of a primary droplet.

The term “soluble” describes a chemical element the solubility of which is greater than 0.1 g.L⁻¹in a liquid phase, preferentially greater than 0.5 g.L⁻¹ and preferentially greater than 1 g.L⁻¹.

FIG. 1 schematically illustrates a system for producing solid clusters 1 according to an embodiment of the invention. Panel A of FIG. 1 schematically illustrates the whole of a system for producing solid clusters 1 according to an embodiment of the invention. Panel B of FIG. 1 illustrates the heights h₁, h₂ and the widths l₁ and l₂ of fluidic channels according to the invention. A system for producing solid clusters 1 comprises a microfluidic system, comprising an element 6 for producing primary droplets 16 and a main channel 9 for forming solid clusters 1. The element 6 for producing primary droplets 14 comprises an outlet 12 of width l₁, connecting the element 6 for producing primary droplets 16 and the main channel 9.

The element 6 for producing primary droplets 14 comprises a plurality of fluidic channels of height h₁, arranged so as to form at least one junction selected from a T-junction and an X-junction. An implementation of a process according to the invention comprises a step consisting in forming at least one primary droplet 14, of at least one dispersed phase 15, comprising monomers 18, capable of forming a type of polymer by cross-linking, in a continuous phase 16, by controlling flows in at least one junction selected from a T-junction and an X-junction 8. In the embodiment illustrated in FIG. 1, an X-junction 8 produces two primary droplets 14 of two dispersed phases 15 in a continuous phase 16 in a synchronous manner, so as to produce a train of primary droplets 14. Consequently, the fluidic channels of the element 6 for producing droplets contain a dispersed liquid phase 15 and a continuous liquid phase 16, said dispersed phase comprising monomers 18. In other embodiments of the invention, more than two primary droplets 14 can be produced so as to produce a train of primary droplets 14 in the element 6 for producing primary droplets 14.

In embodiments of the invention, oil (dispersed phase 15) in water (continuous phase 16) or water (dispersed phase 15) in oil (continuous phase 16) emulsions are produced in the element 6 for producing primary droplets 14. In the case of oil in water emulsions, fluorinated oil (FC3283, 3M, registered trademark) and water containing sodium dodecyl sulfate (SDS) as surfactant can be used. The concentration of SDS in the water can vary from 0.5 critical micelle concentration (CMC) to 10 CMC. In the case of water in oil emulsions, deionized water in mineral oil, containing for example Span80 (registered trademark) as surfactant, can be used. Formulations of emulsions containing a concentration of surfactants greater than the CMC lead to the presence of adhesive depletion forces around the secondary droplets 17 generated by micelles. This surfactant concentration range also prevents the coalescence of the primary droplets 14 or the secondary droplets 17 by stabilizing the film between each droplet. By increasing the ionic force in an oil in water emulsion, for example by adding one or more salts, the electrostatic repulsion decreases and the adhesion between the droplets increases. This effect is visible by a flattening of the surfaces of the droplets in contact.

The main channel 9 for forming solid clusters 1 is of height h₂ and comprises an inlet of width l₂, strictly greater than l₁. It has a main axis 19. The height h₁ is strictly less than h₂ so as to form a step 10 between the element 6 for producing primary droplets 14 and the main channel 9, as described in Malloggi, F., Pannacci, N., Attia, R., Monti, F., Mary, P., Willaime, H., . . . & Poncet, P. (2009), Monodisperse colloids synthesized with nanofluidic technology, Langmuir, 26(4), 2369-2373. An implementation of a process according to the invention comprises a step consisting in forming a plurality of adjacent secondary droplets 17 from a primary droplet 14 or a train of primary droplets 14, by pushing each primary droplet 14 with the continuous phase 16 over the step 10 in the main channel 9. When passing over the step 10, a primary droplet 14 or a train of primary droplets 14 breaks up into a plurality of secondary droplets 17, substantially spherical, and adjacent to each other, a secondary droplet 17 being adjacent to at least one other secondary droplet 17. One of the liquid phases comprises at least one type of surfactant, or surface-active. In an embodiment of the invention, the concentration of the surfactant(s) in one of the liquid phases is at least strictly greater than the CMC, and preferentially greater than ten times the CMC. An increase in the concentration of surfactants increases the adhesive forces between the secondary droplets 17, by depletion, and allows them to be transported in the main channel 9 in the form of clusters of secondary droplets 17.

The microfluidic system, which comprises, in an embodiment of the invention illustrated in FIG. 1, the element 6 for producing primary droplets 16 and the main channel 9, can be achieved by a two-level soft photolithography technique. The height h₁ can for example be between 0.5 and 10 μm, preferentially between 1 and 7 μm, and the width lₗ can be between 2 and 100 μm, preferentially between 10 and 50 μm. The height h₂ can be between 10 μm and 200 μm, and preferentially between 22 μm and 150 μm.

Several microfluidic systems can be obtained simultaneously by a collective manufacturing process. The ensemble of microfluidic systems is for example made by standard soft photolithography methods and by molding a replica of one or more channels, for example in polydimethylsiloxane (PDMS). The molds are made by photolithography of one or more layers of epoxy photoresist (SU8, Microchem, registered trademark). Other materials can be used to make the microfluidic channels (NOA, glass, etc.).

In an embodiment of the invention, the system for producing solid clusters 1 comprises at least two second channels 7, connected to the main channel 9 and arranged symmetrically with respect to the main axis 19 of the main channel 9. In an embodiment of the system according to the invention described in FIG. 1, these two channels are each located approximately 200 μm from the main axis 19. These second channels 7 are additional means of flow control in the main channel 9, influencing the formation of secondary droplets 17 during the break-up of the primary droplets 14 in the inlet of the main channel 9. These second channels 7 also define the dynamics of the clusters of secondary droplets 17, formed in the main channel 9.

An example geometry of a microfluidic system, implemented in an embodiment of the invention, bringing together the element 6 for producing primary droplets 16 and the main channel 9, is described in Shen, B., Leman, M., Reyssat, M., & Tabeling, P. (2014), Dynamics of a small number of droplets in microfluidic Hele-Shaw cells, Experiments in Fluids, 55(5), 1-10.

FIG. 1 illustrates the synchronous formation of two primary droplets 14 in the element 6 for producing primary droplets 14. The two dispersed phases 15 are for example of different chemical compositions. Two T-junctions, arranged facing each other, allow the synchronous formation of two primary droplets 14, so as to form two adjacent primary droplets 14 in the element for producing primary droplets 6. This arrangement is illustrated in FIG. 1. When passing over the step 10, the secondary droplets 17 formed in the main channel 9 may be of different chemical compositions, without being mixed. The secondary droplets 17 of different compositions are differentiated by light gray or dark gray in FIG. 1.

As a function of the flow conditions, imposed by the flow control of the dispersed phase 15, of the continuous phase 16 (of the element 6 for producing primary droplets 14 and of the second channels 7), the primary droplets 14 and/or the trains of primary droplets 14 arrive at the step 10 and each primary droplet separates into a plurality of secondary droplets 17 of substantially equal or different sizes and volumes. In embodiments of the invention, the diameter d of the secondary droplets 17 can be between 100 nm and 1 mm. This effect can be observed in the form of a Cantor staircase, or Devil's staircase, and is detailed in FIG. 17. The secondary droplets 17 generated by the step 10 are initially located near the upper wall of the main channel 9. As described above, the secondary droplets 17 cluster directly following their production, without coalescing. Two situations can be distinguished. The first, called planar, corresponds to the case where the secondary droplets 17 cluster according to a planar conformation. The second, called 3D, corresponds to the case where the secondary droplets 17 cluster according to a conformation in three spatial dimensions. The adhesion forces between the secondary droplets 17 can be adjusted by the choice of the concentration of salts and surfactants: the planar situation is favored by choosing weak adhesion forces between the secondary droplets 17, and the 3D situation is favored by choosing stronger adhesion forces between the secondary droplets 17 when the various secondary droplets 17 are in contact, without significantly deforming the part of their wall in contact with another droplet. Stronger adhesion forces can lead to significant deformation of the surfaces between the droplets in contact. In both situations, the adhesion mechanism is partly caused by depletion forces resulting from the presence of micelles.

FIG. 2 is a photograph taken under a confocal microscope of part of the system according to the invention. The photograph is taken with a long exposure time, during the production of secondary droplets 17. The trajectory of the various clusters of secondary droplets 17 is illustrated in FIG. 2 by means of this exposure time. FIG. 2 illustrates the confinement of the clusters of secondary droplets 17 in the main channel 9. The rectangular photograph marked by the black arrow is a photograph according to a sectional view in the plane defined by the height and the width of the main channel 9. The rectangle at the bottom of FIG. 2 illustrates a digital simulation of the flow, carried out in the same plane as the preceding sectional view. The simulation is carried out according to the finite element method with the COMSOL software (registered trademark). These two images of sectional views in the main channel 9 illustrate the confinement of the flow coming from the element 6 for producing primary droplets 14, in a tube substantially close to the main axis 19 of the main channel 9. The flow of the continuous phase 16 coming from the flow control channels 7 contributes to this confinement. The height of the tube is, in this embodiment of the invention, less than 50 μm. A single-phase flow is simulated during the digital simulation. The streamlines, coming from a channel of the element 6 for producing primary droplets 14, disposed at a limit of the height of the main channel 9, are confined within a thin tube, corresponding to the tube defined by the transport of the clusters of secondary droplets 17.

FIG. 3 illustrates the velocity of clusters of secondary droplets 17 as a function of the mean flow velocity U_{∞} in the main channel 9. The measured cluster velocity U_{C} corresponds to the velocity of an cluster of secondary droplets 17 the conformation of which is planar and diamond-shaped. The grayed region corresponds to transport by passive advection, delimited by two borderline cases: U_{C}=U₂₈ (case of the cluster blocking the main channel 9) and U_{c=}3/2 U_{∞}(case of a particular cluster transported along the main axis 19 of the main channel 9). The inset illustrates a planar cluster of secondary droplets 17 having a diamond conformation. The scale bar corresponds to a length of 5 μm. The velocity of the clusters of secondary droplets 17 is significantly lower than a passive advection velocity by the flow. This effect, known for isolated droplets, is hypothetically due to a neighboring effect of the clusters of secondary droplets 17 with the channel walls, resulting in frictions via the continuous phase 16. For a ratio of one-third between h₂ and the diameter of a secondary droplet 17, the velocity of the clusters of secondary droplets 17 is reduced by 40% to 50% in comparison with that which they would adopt in passive advection. Similar characteristics describe the flow of clusters in a 3D situation.

FIG. 4 schematically illustrates the flow field associated with an isolated droplet advected in a microchannel at a velocity below the mean flow velocity. The black arrows correspond to the flow field in the laboratory reference frame. The curved gray lines (on each side of the droplet and connected to the droplet) correspond to the flow field in the reference frame of the droplet. The droplet is in the center of a dipolar recirculation system. During the presence of several neighboring droplets, the various recirculation systems can interact.

FIG. 5 illustrates the organization dynamics of clusters of secondary droplets 17. Panel A of FIG. 5 illustrates a sequence of 8 photographs corresponding to the organization dynamics of an cluster of three secondary droplets 17 toward a planar equilateral triangle conformation (top of panel A of FIG. 5) and a sequence of 8 diagrams corresponding to a digital simulation based on a model described below (bottom of panel A of FIG. 5). The scale bar corresponds to 50 μm. The time interval between each photograph is 0.12 s. The conformation of the cluster is stationary 0.84 s after its formation. The dispersed phase 15 corresponds to fluorinated oil and the continuous phase 16 corresponds to water containing 2% by weight SDS. Panel A′ of FIG. 5 is an illustration of the recirculations associated with each secondary droplet 17 of the cluster.

Panel B of FIG. 5 illustrates a sequence of 8 photographs corresponding to the organization dynamics of an cluster of 4 secondary droplets 17 toward a planar rhombus conformation (top of panel B of FIG. 5) and a sequence of 8 diagrams corresponding to a digital simulation based on a model described below (bottom of panel B of FIG. 5). The scale bar corresponds to 50 μm. The time interval between each photograph is 0.4 s. Panel B′ of FIG. 5 is an illustration of the recirculations associated with each secondary droplet 17 of the cluster.

Panel C of FIG. 5 illustrates a sequence of 8 photographs corresponding to the organization dynamics of an cluster of five secondary droplets 17 toward a planar trapezoidal conformation (top of panel C of FIG. 5) and a sequence of 8 diagrams corresponding to a digital simulation based on a model described below (bottom of panel C of FIG. 5). The scale bar corresponds to 5 μm. Panel C′ of FIG. 5 is an illustration of the recirculations associated with each secondary droplet 17 of the cluster.

Panel D of FIG. 5 illustrates a sequence of 8 photographs corresponding to the organization dynamics of an cluster of four secondary droplets 17 toward a 3D tetrahedral conformation (top of panel A of FIG. 5) and a sequence of 8 diagrams corresponding to a digital simulation based on a model described below (bottom of panel A of FIG. 5). The scale bar corresponds to 5 μm. The dispersed phase 15 corresponds to fluorinated oil and the continuous phase 16 corresponds to water containing 2% by weight SDS and 5% by weight sodium chloride (NaCl). Panel D′ of FIG. 5 is an illustration of the recirculations associated with each secondary droplet 17 of the cluster.

Panels A to C of FIG. 5 illustrate clusters produced under surfactant and salt conditions capable of maintaining so-called average adhesion between various secondary droplets 17 of the cluster. Clusters in a planar situation are followed during each sequence. The first photograph of each cluster corresponds to a distance along the x-axis of 300 μm from the inlet of the main channel 9 for panel A and panel B of FIG. 5, 240 μm for panel C of FIGS. 5 and 20 μm for panel D of FIG. 5. In panels A and B of FIG. 5, the clusters initially have a twisted or curved chain conformation. The curvature of the streamlines located directly after the step 10 at the inlet of the main channel 9, and the production of secondary droplets 17 in series, are the source of these morphologies. Moreover, the flow-related constraints on the clusters in the inlet of the main channel 9 decrease rapidly along the x-axis, leading the secondary droplets 17 to approach and cluster. The clusters formed then undergo internal rearrangements and may finally be arranged in symmetrical conformations, i.e., in the case of planar situations, an equilateral horizontal triangle for N=3, a diamond for N=4 and a flat isosceles trapezoid for N=5 (panels A to C of FIG. 5, respectively). The rearrangement lasts a few seconds before ending in a stationary conformation.

During the rearrangements, the secondary droplets 17 roll over each other in a horizontal plane. Once the rearrangement occurs, the number of contacts between droplets C is greater than or equal to that of the initial arrangement after passing over the step 10. The level of symmetry of the cluster is greater than or equal to that of the cluster formed after the step 10. This self-assembly process can produce clusters the conformation of which does not depend on the initial production conditions of the clusters of secondary droplets 17.

Panel D of FIG. 5 illustrates the production of a cluster the conformation of which is a compact tetrahedron. The production of clusters in this embodiment of the invention is carried out under conditions of ionic force and surfactant concentration suited to strong adhesion between the various secondary droplets 17. The sequence of panel D of FIG. 5 illustrates an increase in the symmetry of the conformation.

The inventors discovered that by increasing the ratio between h₂ and the radius d of a secondary droplet 17, i.e., by decreasing the confinement of an cluster in the main channel 9, the forces allowing the rearrangement illustrated in panels A to D of FIG. 5 are not present or are hardly present. In the case of a high ratio between h₂ and d, the clusters of secondary droplets 17 retain their initial conformation after production by passing over the step 10, and are transported with this conformation along the main channel 9. These experiments indicate a mechanism initiated by the walls of the main channel 9. The arguments proposed are based on the following hypothesis: for moderate h₂/d ratios, for example between 1 and 5 (with d the diameter of a secondary droplet 17), the velocity of the clusters of secondary droplets 17 is decreased by approximately 40 to 50%. The slowing down of the clusters leads to the development of a dipolar hydrodynamic field around a secondary droplet 17, as illustrated in FIG. 4. In a reference frame in which the velocity corresponds to the mean velocity of the continuous phase 16 in the main channel 9, a cluster moves backward. Owing to s mass conservation, the fluid which the cluster must displace to recede recirculates forward (in the positive x direction), generating dipolar flow field patterns as illustrated in FIG. 5. Within each cluster, the horizontal recirculations of a secondary droplet 17 (in the plane defined by x and y) exert a viscous drag on at least one other secondary droplet 17, leading to a displacement of the secondary droplets 17 with respect to each other, and leading to a conformational change of the entire cluster.

Dipolar interactions may explain, at a qualitative level, the dynamics of an cluster of secondary droplets 17 in the main channel 9. In the case of N=3, the secondary droplet 17 located at the rear of the cluster is subjected to the recirculations generated by the other secondary droplets 17. These recirculations lead the rear secondary droplet 17 toward the center of the doublet formed by the other two droplets. As it arrives, the action of the recirculations cancels out by symmetry and the conformation of the cluster becomes stationary. In the case of N=4, the two droplets initially located at the rear of the cluster are subjected to the same effect (illustrated in panel B of FIG. 5). In this case, the action of the recirculations is strongest for the rearmost secondary droplet 17 of the cluster, which explains a higher velocity of this secondary droplet 17 than the other in the reorganization of the cluster. Similarly, after having adopted a symmetrical diamond conformation, the dipolar hydrodynamic forces cancel out and the morphology of the cluster evolves no further. A similar reasoning can be followed for N=5 and a three-dimensional conformation.

The inventors discovered a mechanism capable of explaining the experiments illustrated by the preceding figures in the case of planar situations.

The behavior of the clusters is modelled in a planar situation by a dimensionless equation, while being placed in a frame of reference moving with U_{∞}, with R (the radius of a secondary droplet 17) as the characteristic distance and π=R/β(1−β)U₂₈ (in which U_{∞} is the velocity at infinity) as the characteristic time:

$$\frac{d {\tilde{r}}_{i}}{d \tilde{t}} = {\sum }_{j \neq i} ( {( \frac{1}{\tilde{{r}_{ij}}} )}^{2} {e}_{∞} - 2 {( \frac{1}{\tilde{{r}_{ij}}} )}^{2} {e}_{ij} ( {e}_{ij} , {e}_{∞} ) ) + Y {\sum }_{j \neq 1} ( {( \frac{1}{\tilde{{r}_{ij}} - 2} )}^{2} ) {e}_{ij} + {G}_{ij} \qquad ( 1 )$$

with

$$\frac{d {\tilde{r}}_{i}}{d \tilde{t}}$$

the dimensionless velocity of a secondary droplet 17 i at position \tilde{r}ᵢ at dimensionless time \tilde{t}, e_{∞} the unit vector projected on the mean flow at infinity, β the reduction factor of the cluster velocity, [symbol] the distance separating the center of a secondary droplet 17i and a secondary droplet 17j, Gᵢⱼ a repulsive short range term preventing the interpenetration of the secondary droplets 17 and Y a dimensionless number given by the equation (2):

$$Y = \frac{A}{72 πη {R}^{2} {U}_{∞} ( 1 - β )} \qquad ( 2 )$$

with A the constant used in the attractive part of the potential between secondary droplets 17 and η the viscosity of the continuous phase 16. The ratio Y represents the ratio of the adhesive forces between secondary droplets 17 to the dipolar forces. For a small Y, the adhesion between secondary droplets 17 is small and the secondary droplets 17 separate out. For a high Y, the secondary droplets 17 stick together permanently without allowing rearrangement.

In an embodiment of the invention, the regime is one in which Y is high, i.e., greater than or equal to 0.1, preferentially greater than or equal to 1, and preferentially greater than 10. The solutions of the equation (1), obtained with the initial conditions of the various panels of FIG. 5, are illustrated by the sequences whose droplets are represented in line, in panels A to C of FIG. 5.

The experimental and theoretical conformations can be adjusted with sufficient exactitude to account for phenomena present in the invention.

The model developed above makes it possible to predict the time s necessary before a cluster of secondary droplets 17 is arranged in a stationary conformation. Taking into account the sizes and velocities measured for example in the embodiments of FIG. 5 and a factor β strictly less than 1, τ is on the order of a few seconds, in keeping with the times measured experimentally. The self-assembly rate can be increase by increasing U_{∞} and by decreasing the size of the secondary droplets 17. The decrease in size of the secondary droplets 17 can be achieved by producing secondary droplets 17 by a process according to the invention.

After a time greater than or equal to the characteristic time τ, for example greater than or equal to 0.1 s, the clusters of secondary droplets 17 have a stationary conformation. Typically, clusters in the form of a chain of secondary droplets 17 are produced for high flow rates and more compact conformations for low flow rates.

FIG. 6 illustrates the experimental morphology of the clusters of secondary droplets 17 as a function of the number of contacts between secondary droplets 17 in a cluster and as a function of the number of secondary droplets 17 of the cluster. The scale bar corresponds to a length of 5 μm in the inset photographs. The experimental conformations of clusters of secondary droplets 17 produced by a process according to the invention are for example in the shape of T, a cross, a trapezoid and a triangle. One or more axial symmetries characterize the conformation obtained for each cluster when its conformation is stationary. This axial symmetry does not exist during the production of secondary droplets 17 near the step 10. The auto-assembly mechanism leads the clusters of secondary droplets 17 to at least increase their degree of axial symmetry. The stationary conformations formed after at least a characteristic time are maintained by depletion forces. The conformation of a cluster of secondary droplets 17 subsequently evolves no further if the surfactant concentrations and the ionic force of the medium remains constant.

The planar conformations of the clusters of secondary droplets 17 are classified in FIG. 6 as a function of the number N of secondary droplets 17 of the cluster and as a function of the number C of contacts between secondary droplets 17 of a cluster. In an embodiment of the invention illustrated by FIG. 5, the ensemble of conformations is included in the gray triangular zone. The lower limit is defined by the line C=N−1, corresponding to conformations in which contacts between secondary droplets 17 are minimal, i.e., chains. The upper limit is defined by the line C=2N−3, corresponding to conformations in which contacts between secondary droplets 17 are maximal for a planar situation. Inside the region defined by these two limits, there exists a plurality of conformations, for example T- or cross-shaped.

FIG. 7 illustrates the morphology of the clusters of secondary droplets 17 as a function of the number of contacts between secondary droplets 17 in a cluster and as a function of the number of secondary droplets 17 of the cluster, calculated by modeling according to the dipolar model of the forces exerted on the secondary droplets 17. The scale bar corresponds to a length of 5 μm in the inset photographs. The black squares correspond to the structures observed experimentally and the gray squares correspond to the structures which are not observed experimentally.

FIG. 6 and FIG. 7 illustrate the existence of a unique conformation of clusters of secondary droplets 17 if N is strictly less than 6 for a defined pair (N, C). Degeneracies are observed for N=6. A degeneracy is for example illustrated in FIG. 6 for N=6 and C=9.

The equation (1) makes it possible to calculate the ensemble of stationary conformations of clusters of secondary droplets 17 produced by a process according to an embodiment of the invention. In terms of a dynamic system, each conformation corresponds to a fixed point in space of phases of dimension 2N. FIG. 7 illustrates the stationary conformations observed numerically. By comparing with the conformations illustrated in FIG. 6, the ensemble of experimental conformations is reproduced in a numerical manner. FIG. 7 illustrates the possibility of producing at least three other spatial conformations of the phases used: two conformations in the shape of a T and an H, and a third conformation in the shape of a mushroom.

FIG. 8 is a histogram illustrating the aspect ratios of the clusters of secondary droplets 17. The aspect ratio illustrated in FIG. 8 is defined by λ=Dₘₐₓ/Dₘᵢₙ for a population of 2134 clusters comprising five secondary droplets 17, where Dₘₐₓ is the maximum Feret diameter and Dₘᵢₙ is the minimum Feret diameter. The coefficient of variation, defined by the quantity 100. σ/<λ>, where σ is the standard deviation and <λ> is the average aspect ratio, is approximately 2%. The top inset is a photograph illustrating the in-line production of six clusters of secondary droplets 17. The bottom left inset is a histogram illustrating λ for a population of 152 doublets (N=2), 382 triangles (N=3) and 217 diamonds (N=4).

In the ensemble of 2134 clusters of five secondary droplets 17 illustrated by the histogram in FIG. 8, 95% of these have the same trapezoidal conformation, defined by N=5 and C=7. In these 95% of the clusters, the coefficient of variation in size of the clusters is less than 2%. The other clusters have a cross or T conformation and, in a few cases, nonstationary conformations. In other embodiments of the invention, for example for N=2, 3 or 4, the coefficient of variation in size of the composition of clusters of secondary droplets 17 produced is less than 5%, preferentially less than 3% and preferentially less than 2%.

In the embodiments of the invention illustrated in FIG. 8, the production of the clusters of secondary droplets 17 is characterized by a high flow rate: for example, 1.2×10⁵ trimers (clusters made up of three secondary droplets 17) of approximately 15 μm diameter can be produced in 245 minutes. This number makes it possible to produce a sample made up of solid clusters 1 having a volume of 2 mm×20 μm×20 μm, sufficient to exhibit macroscopic behavior. The invention makes it possible in this sense to solve one of the technical problems of the prior art.

FIG. 9 illustrates clusters of secondary droplets 17 in which the secondary droplets 17 are of different sizes. The top left photograph of FIG. 9 illustrates a cluster of secondary droplets 17 having an anisotropic conformation. Two secondary droplets 17 have the same diameter (type B), and another secondary droplet 17 has a significantly smaller diameter (type A). The conformation of the cluster is in this case type AB₂. The top right photograph of FIG. 9 illustrates a cluster of secondary droplets 17 having an anisotropic conformation. Three secondary droplets 17 have the same diameter (type B), and another secondary droplet 17 has a significantly smaller diameter (type A). The conformation of the cluster is in this case type AB₃. The scale bar corresponds to a length of 5 μm. The two photographs of the bottom of the figure illustrate isotropic micrometric clusters. The scale bar corresponds to a length of 5 μm. The geometrically anisotropic conformations illustrated in the photographs at the top of FIG. 9 are produced, in an embodiment of the invention, by adjusting the volume of the primary droplets 14 so as to produce secondary droplets 17 of different volumes, according to break-ups when passing over the step 10 the volumes of which follow a Cantor staircase (described below).

FIG. 10 illustrates clusters of secondary droplets 17 in which at least one secondary droplet 17 has a chemical composition substantially different from at least one other secondary droplet 17. The clusters of secondary droplets 17 illustrated in FIG. 10 can have both chemical anisotropy and geometrical anisotropy, as illustrated in FIG. 9. The top left photograph of FIG. 10 illustrates a cluster in which the two secondary droplets 17 have a first chemical composition D and a secondary droplet 17 has a second chemical composition C, the cluster having a chemical conformation of type CD₂. The top right photograph of FIG. 10 illustrates a cluster having a chemical conformation of type CD₂ and a linear spatial conformation. The photographs at the bottom of FIG. 10 illustrate clusters having both chemical and geometrical anisotropies, comprising four secondary droplets 17 (heterogeneous tetramers). The scale bar corresponds to a length of 50 μm.

FIG. 11 illustrates clusters of secondary droplets 17 in which a secondary droplet 17 comprises magnetic nano-/microparticles 5. More generally, according to an embodiment of the invention, clusters of secondary droplets 17 in which at least one secondary droplet 17 comprises magnetic nano-/microparticles 5 can be produced. In this embodiment of the invention, the dispersed phase 15 corresponds for example to fluorinated oil and the continuous phase 16 corresponds for example to water containing 2% by weight SDS. Magnetic nano-/microparticles 5 (ferromagnetic) are mixed in one of the dispersed phases 15 before the production of the primary droplets 14 in order to produce heterogeneous clusters of secondary droplets 17. The top left photograph of FIG. 11 illustrates a magnetic heterogeneous cluster of secondary droplets 17, having a geometrical conformation of type AB₂. The top right photograph of FIG. 11 illustrates a magnetic heterogeneous cluster of secondary droplets 17, having a linear geometrical conformation of type AB₂. The bottom left photograph of FIG. 11 illustrates an cluster of secondary droplets 17 of magnetic heterodimer type and the bottom right photograph of FIG. 11 illustrates an cluster of secondary droplets 17 of heterotrimer type. The scale bar corresponds to a length of 50 μm.

FIG. 12 illustrates heterogeneous clusters of secondary droplets 17 having three-dimensional conformations. Panel A of FIG. 12 comprises photographs illustrating polyhedral clusters of secondary droplets 17 comprising 4, 5 and 6 secondary droplets 17 (in the top left, top right and bottom two photographs, respectively). The top left photograph illustrates a tetrahedral cluster comprising three secondary droplets 17 comprising magnetic nano-/microparticles 5. The scale bar corresponds to a length of 50 μm for the top left photograph and 5 μm for the other photographs of panel A of FIG. 12. Panel B of FIG. 12 illustrates three-dimensional representations of the clusters of panel A of FIG. 12. The dark gray spheres correspond to secondary droplets 17 comprising magnetic nano-/microparticles 5 and the light gray sphere corresponds to a non-magnetic secondary droplet 17.

FIG. 13 illustrates the action of a magnetic field on a magnetic cluster of secondary droplets 17. The left photograph illustrates an cluster comprising 12 secondary droplets 17, of which 6 comprise magnetic nano-/microparticles 5, produced by a process according to an embodiment of the invention. The right-hand photograph (indicated by the black arrow between the two photographs) illustrates the same cluster in the presence of a local magnetic field B (illustrated by the black arrow pointing toward “B”). In the presence of a local magnetic field B, the secondary droplets 17 comprising magnetic nano-/microparticles 5 align and the cluster takes a helical conformation. The schematic representation at right illustrates the helical conformation of the cluster controlled by the magnetic field B.

FIG. 14 illustrates a solid cluster 1 according to an embodiment of the invention. The production of a solid cluster 1 from a cluster of secondary droplets 17 requires solidifying the secondary droplets 17 and attaching them to each other. A system for producing solid clusters 1 of at least two substantially ellipsoidal microparticles 2, carried out according to the invention, comprises a system of physical initiation of polymerization 11 capable of initiating polymerization in the main channel 9. According to the embodiments of the invention, the system of physical initiation of polymerization 11 may be selected from at least a local illumination system emitting ultraviolet light and a heating system.

To produce one or more solid clusters 1, a process for forming solid clusters 1 according to the invention comprises at least one step consisting in initiating the polymerization in adjacent secondary droplets 17, i.e., comprised within the same cluster of secondary droplets 17, transported in the main channel 9 with at least one system of physical initiation of polymerization 11.

In an embodiment of a process according to the invention, the monomers of the dispersed phase(s) 15 are selected from at least monomers substantially soluble in the continuous phase 16. For example, one may select monomers comprising acrylates and carry out in situ polymerization of the dispersed phase 15 and part of the continuous phase 16 so as to form one or more solid junctions between the various polymerized secondary droplets 17, called microparticles 2.

Panel A of FIG. 14 is a photograph obtained with a scanning electron microscope of a solid cluster 1 according to an embodiment of the invention. The solid cluster 1 illustrated comprises two microparticles 2 (doublet). This solid cluster is produced by the process described above during which a dimer-type cluster of secondary droplets 17 has been polymerized. The solid cluster 1 comprises two substantially spherical particles, each said microparticle 2 comprising at least one type of cross-linked polymer 3, and is characterized in that each microparticle 2 is interconnected in an integral and materially continuous manner with at least one other microparticle 2 by a solid junction 4, said junction 4 comprising at least the type of cross-linked polymer 3. The inventors discovered that the in situ polymerization of an cluster of secondary droplets 17 makes it possible, in the embodiments of the invention, to form solid and continuous junctions 4. This effect is unexpected with respect to the state of the art, because the secondary droplets 17 of the clusters are separated by two distinct interfaces, forming a continuous-phase thin film between two adjacent secondary droplets 17. The scale bar corresponds to a length of 10 μm.

More generally, the particles of a solid cluster 1 according to an embodiment of the invention may be substantially ellipsoidal.

More generally, a solid cluster 1 according to an embodiment of the invention may comprise at least two particles 2.

Panel B of FIG. 14 is a photograph obtained with a scanning electron microscope of a solid cluster 1 according to an embodiment of the invention. It illustrates a junction 4 of a solid cluster 1 between two microparticles 2. The scale bar corresponds to a length of 1 micrometer.

FIG. 15 illustrates a solid cluster 1 according to an embodiment of the invention. Panel A of FIG. 15 illustrates a solid cluster 1 comprising three microparticles 2 (triplet). This solid cluster 1 is produced by a process described above during which a trimer-type cluster of secondary droplets 17, in an isosceles triangle-type conformation, has been polymerized. The scale bar corresponds to a length of 10 μm.

Panel B of FIG. 15 is a photograph obtained with a scanning electron microscope of a solid cluster 1 according to an embodiment of the invention. It illustrates three junctions 4 of a solid cluster 1 between three microparticles 2. The scale bar corresponds to a length of 1 micrometer.

FIG. 16 illustrates solid clusters 1 according to embodiments of the invention. Panel A of FIG. 16 illustrates a solid cluster 1 comprising four microparticles 2 (quadruplet). This solid cluster 1 is produced by a process described above during which a tetramer-type cluster of secondary droplets 17, in a diamond-type conformation, has been polymerized. The scale bar corresponds to a length of 10 μm. Panel B of FIG. 16 illustrates a solid cluster 1 comprising five microparticles 2 (quintuplet). This solid cluster 1 is produced by a process described above during which a cluster of five secondary droplets 17 in a conformation in three dimensions, has been polymerized. The scale bar corresponds to a length of 10 μm.

Panel C of FIG. 16 illustrates a composition of triplet-type solid clusters 1 according to an embodiment of the invention. The monodispersity properties of the clusters of secondary droplets 17 described above may be preserved during their polymerization. In an embodiment of the invention, the coefficient of variation in size of a composition of solid clusters 1 is less than 15%, preferentially less than 10% and preferentially less than 5%.

FIG. 17 illustrates a step of photopolymerization of an cluster by a process implemented according to an embodiment of the invention. One uses in this example a dispersed phase 15 comprising acrylates, preferentially diethylene glycol diacrylate, (used as solvent and as monomers 18) capable of polymerizing in the dispersed phase 15 and to a lesser degree in the continuous phase 16 so as to form the junctions 4 described above. In this example, the dispersed phase contains 5% 2-hydroxy-2-methylpropiophenone, which is a polymerization reaction initiator capable of being initiated by ultraviolet light. The continuous phase 16 contains water as solvent and 2% SDS. The adjacent secondary droplets 17, forming clusters, formed in the main channel 9 by a process described in the preceding figures, are illuminated locally in the main channel 9, in a UV illumination zone 13, described in FIG. 1. The UV illumination may be focused on a plane at the mid-height of h₂. A mask comprising a pattern capable of transmitting ultraviolet light locally is introduced between the ultraviolet illumination and the objective (this illumination method following a pattern is described in Dendukuri, D., Pregibon, D. C., Collins, J., Hatton, T. A., & Doyle, P. S., 2006, Continuous-flow lithography for high-throughput microparticle synthesis, Nature Materials, 5(5), 365-369). The first two photographs of FIG. 17 starting from the left illustrate the transport of a cluster of secondary droplets 17 before illumination (or exposure) with UV light. The third photograph illustrates the entry of a cluster of secondary droplets 17 in the UV illumination zone 13, corresponding to the initial illumination time (t=0 s). The clusters solidify in less than one second, preferentially in less than 200 ms. After solidification, the clusters shrink slightly. The behavior of the clusters transported in the main channel 9 is immediately modified after solidification. Their transport velocity increases, and the solid clusters 1 undergo rotations. As a function of the solubility of the monomer 18, polymerizations may be initiated in the continuous phase 16, preferentially in the regions of the continuous phase 16 confined between the microparticles 2. This or these junction(s) 4, the maximum size of which is preferentially less than 1 μm, confer a strong adhesion between the microparticles 2. The solidity of the solid clusters 1 produced according to this process implemented according to an embodiment of the invention makes it possible to extract the solid clusters 1 from the main channel 9, to wash them and to preserve them, without changing their properties, so as to use them as building blocks for forming materials. In embodiments of the invention, the solubility of the monomers is greater than 0.1 g.L⁻¹ in the continuous phase 16, preferentially greater than 0.5 g.L⁻¹ and preferentially greater than 1 g.L⁻¹.

Generally, the inventors also discovered that a polymerization reaction of the monomers solubilized in the continuous phase 16 between at least two adjacent secondary droplets 17, is favored and/or producible in the presence of a polymerization initiator in the continuous phase. The presence of an initiator and/or a sufficient quantity of an initiator in the continuous phase 16 for polymerizing an cluster of secondary droplets 17 into a solid cluster 1 in the main channel, is possible if the initiator is soluble in the continuous phase 16. By “soluble” is meant that the solubility, or the mass concentration, of at least one initiator in the continuous phase 16 is greater than 0.1 g.L⁻¹, preferentially greater than 0.5 g.L⁻¹ and preferentially greater than 1 g.L ⁻¹ . In a process concerned by the invention, the dispersed phase 15 comprises at least one polymerization initiator, advantageously soluble in the continuous phase. The solubility of the initiator used in the polymerization illustrated in FIG. 17, 2-hydroxy-2-methylpropiophenone, is approximately equal to 13 g.L^{—1} in the aqueous phase. The aqueous phase corresponds to the continuous phase in this example.

In a variant, solid clusters 1 may be produced by preparing an emulsion the continuous phase 16 of which is oil. In this embodiment, the dispersed phase 15 contains (hydroxyethyl)methacrylate (HEMA), 10% by weight 2-hydroxy-2-methylpropiophenone and 10% by weight ethylene glycol diacrylate. The continuous phase 16 may comprise hexadecane and 7% silicone oil (for example V200), as well as 2% by weight ABIL-EM 180 (surfactant).

Generally, the monomer 18 may comprise an acrylate or diacrylate group.

In a variant, if the system for producing solid clusters 1 comprises a heating system, one of the phases may comprise azobisisobutyronitrile so as to initiate the reaction. The heating system may be achieved by an arrangement of electrodes in proximity to the microchannels, capable of heating the channels locally by the Joule effect.

In the embodiments of the invention, a stationary spatial reorganization (rearrangement) of a cluster of secondary droplets 17 (or group of adjacent secondary droplets 17) is awaited before initiating polymerization in the cluster. In a variant, the UV illumination zone may be selected so as to take place at a rearrangement time corresponding to a selected conformation of the cluster.

FIG. 18 illustrates the number of secondary droplets 17 produced after passing over a step 10 as a function of the volume of a primary droplet 14.

The number of secondary droplets 17 is counted for a constant flow rate of the continuous phase 16. When a primary droplet 14 arrives on a step 10, it breaks up into several secondary droplets 17. The number of secondary droplets 17 per cluster formed depends on the flow rate of the continuous phase 16 and of the dispersed phase 15. In FIG. 18, the number of secondary droplets 17 N is defined as the cross-sectional area of a cluster divided by the cross-sectional area of the widest droplet. For a fixed flow of the continuous phase 16, this number increases with the volume of a primary droplet 14, according to a staircase function (also called a Cantor staircase or Devil's staircase). This function comprises plateaus on which the secondary droplets 17 have identical volumes and on which N is an integer. Between each plateau, a cluster of secondary droplets 17 comprises secondary droplets 17 having different volumes (for example several having the same volume and a secondary droplet 17 having a smaller volume). In these cases, N is not an integer. In an embodiment of the invention, the solid cluster 1 is produced under conditions corresponding to the plateaus of the function illustrated in FIG. 18 in which the secondary droplets 17 produced are substantially monodisperse. In this manner, the ensemble of microparticles 2 of a cluster is substantially monodisperse. The microparticles 2 of a solid cluster 1 may be substantially of the same size, i.e., the same diameter d in the case of spherical particles. The microparticles 2 have, for example, a diameter between 100 nm and 1 mm, and their coefficient of variation in diameter may be less than 5%. Generally, the solid clusters 1 may be produced under conditions in which the secondary droplets 17 are of different sizes.

1. A system for producing solid clusters (1) of at least two ellipsoidal microparticles (2), wherein said system comprises at least:
a fluidic device comprising at least:
an element for producing primary droplets (6), comprising a plurality of fluidic channels of height h₁, at least one dispersed liquid phase (15) and one continuous liquid phase (16) contained in said fluidic channels, each said dispersed phase (15) comprising monomers (18) selected from at least monomers soluble in said continuous phase (16), the fluidic channels being arranged so as to form at least one junction selected from a T-junction and an X-junction (8) so that at the junction, primary droplets of each dispersed liquid phase are formed in the continuous phase; and
a main channel (9) for forming solid clusters (1), having a main axis (19), of height h₂;
said element for producing primary droplets (6) being connected by said outlet (12) to said inlet of said main channel (9), h₁ being strictly less than h₂ so as to form a step (10) between said element for producing primary droplets (6) and said main channel (9), the passage of each primary droplet over the step causing said primary droplet to separate into a plurality of secondary droplets;
a system of physical initiation of polymerization (11) capable of initiating the polymerization of the secondary droplets in said main channel (9), the polymerized secondary droplets forming solid clusters.

2. The system according to claim 1 comprising at least two second channels (7), called flow control channels, connected to said main channel (9), and arranged symmetrically with respect to said main axis (19).

3. The system according to claim 1 wherein said system of physical initiation of polymerization (11) is selected from a local illumination system emitting ultraviolet light and a heating system.

4. A process for producing solid clusters (1) of at least two ellipsoidal microparticles (2) comprising at least one type of cross-linked polymer (3), comprising at least the steps of:
generating, in fluidic channels, flows of at least one first phase (15), called the dispersed phase, comprising monomers (18) capable of forming said type of polymer (3) by cross-linking, comprising at least one type of surfactant compound, and one second phase (16), called the continuous phase, said monomers (18) being selected from at least monomers soluble in said continuous phase (16), said fluidic channels coming together to form a junction selected from a T-junction and an X-junction (8), so as to form at least one primary droplet (14) of the dispersed phase in the continuous phase;
controlling the flows of said dispersed phase(s) (15) and of said continuous phase (16) so as to push each said primary droplet (14) with said continuous phase (16) over a step (10), toward a main channel (9), the passage of each primary droplet over said step causing the primary droplet to separate into a plurality of adjacent secondary droplets (17);
initiating the polymerization of the adjacent secondary droplets (17) transported in said main channel (9) by means of a system of physical initiation of polymerization (11), the polymerized secondary droplets forming solid clusters.

5. The process according to claim 4 wherein the solubility of said monomers (18) is greater than 1 g.L⁻¹ in said continuous phase (16).

6. The process according to claim 4 comprising an additional step consisting in awaiting a stationary spatial reorganization of a group of said adjacent secondary droplets (17) before initiating said polymerization in said group of adjacent secondary droplets (17).

7. The process according to claim 4 wherein said dispersed phase (15) comprises at least one initiator of a said polymerization.

8. The process according to claim 4 wherein at least one said initiator is soluble in said continuous phase.

9. The process according to claim 7 wherein said initiator is a photoinitiator and wherein said system of physical initiation of polymerization (11) is a local illumination system emitting ultraviolet light, focused into said main channel (9).

10. The process according to claim 4 wherein at least two said adjacent primary droplets (14) are formed during the first step of a process implemented in claim 4, of at least two said dispersed phases (15) having different chemical compositions.

11. The process according to claim 4 wherein at least two said adjacent primary droplets (14) are formed during the first step of a process implemented in claim 4, at least one said dispersed phase (15) comprising magnetic nano-/microparticles (5).

12. The process according to claim 4 comprising an additional step consisting in controlling the flow rate in flow control channels (7) according to one of claims 1 to 3, in order to select a spatial arrangement between said secondary droplets (17) before initiating the polymerization of the third step of the implemented process according to claim 4.

13. The process according to claim 4 wherein said continuous phase (16) comprises a surfactant compound in a concentration at least strictly greater than half of the critical micelle concentration of said surfactant compound in said continuous phase (16).

14. The process according to claim 4 wherein at least one monomer (18) comprises a group selected from an acrylate group and a diacrylate group.

15. A solid cluster (1) of at least two ellipsoidal microparticles (2), each said microparticle (2) comprising at least one type of cross-linked polymer (3), characterized in that each said microparticle (2) is interconnected in an integral and materially continuous manner with at least one other microparticle (2) by a solid junction (4), said junction (4) comprising at least said type of cross-linked polymer (3).

16. The solid cluster (1) according to claim 15 wherein at least one said microparticle (2) is spherical.

17. The solid cluster (1) according to claim 15 wherein the microparticles (2) are of the same size.

18. The solid cluster (1) according to claim 15 wherein at least one said microparticle (2) has a chemical composition different from at least one other said microparticle (2).

19. The solid cluster (1) according to claim 15 wherein at least one said microparticle (2) comprises magnetic nano-/microparticles (5).

20. The solid cluster (1) according to claim 15 wherein at least one said microparticle (2) comprises fluorescent markers.

21. The solid cluster (1) according to claim 15 wherein the centers of mass of said microparticles (2) form at least one element selected from a triangle, a parallelepiped, a line, a T, a tetrahedron, a pyramid, a triangular bipyramid, an octahedron, a pentagonal bipyramid and a helix.

22. A composition of solid clusters (1) according to claim 15 the coefficient of variation in size of which is less than five percent.
